(19) United States
(12) Patent Application Publication
(10) Pub. No.: US 2014/0149310 A1
(43) Pub. Date: May 29, 2014

(54) SELECTION OF IMAGES TO SELECT A PLACE

(71) Applicant: Google Inc., Mountain View, CA (US)

(72) Inventors: Junho RYU, San Jose, CA (US); Jungkhun Byun, Ridgewood, NJ (US)

(73) Assignee: Google Inc., Mountain View, CA (US)

(21) Appl. No.: 13/688,143

(22) Filed: Nov. 28, 2012

(51) Int. Cl. G06Q 30/02

(52) U.S. Cl. CPC G06Q 30/0282
USPC 705/347

(57) ABSTRACT

A computer-implemented method of selecting a place from a set of candidate places. The method includes presenting, for display to a user, multiple images, each image being associated with a part of the set of candidate places. The method also includes receiving an indication of a selection of one of the images, reducing the set of candidate places based on the selected image, and repeating the presenting, receiving, and reducing steps.

### BACKGROUND

1. Field

The present disclosure generally relates to selection of images representing parts of a candidate set of places to select one or more of those places.

2. Description of the Related Art

Collecting ratings and reviews about places from users, for example for ranking restaurants, stores, other businesses, vacation locations, and the like, can be difficult.

First, many people are only interested in interacting with a source for rating information before they visit a place. After they have visited, they often have little or insufficient incentive to return to the source and add information about the place.

Second, even if a person is interest in providing ratings or reviews before they visit a place, they often do not have sufficient information available to provide accurate ratings or reviews until they do actually visit.

Third, many user interfaces for providing ratings and reviews can be too serious or cumbersome for casual users.

### SUMMARY

According to one aspect of the present disclosure, a computer-implemented method of selecting a place from a set of candidate places is provided. The method includes presenting, for display to a user, multiple images, each image being associated with a part of the set of candidate places. The method also includes receiving an indication of a selection of one of the images, and reducing the set of candidate places to the part associated with the selected image. The method further includes repeating the presenting, receiving, and reducing steps.

According to another aspect of the present disclosure, a machine-readable storage medium is provided. The medium includes machine-readable instructions for causing a processor to execute a method of selecting a place from a set of candidate places. The method includes presenting, for display to a user, two images, each image being associated with a part of the set of candidate places. The method also includes receiving an indication of a selection of one of the images and reducing the set of candidate places to the part associated with the selected image.

According to a further aspect of the present disclosure, a system for selecting a place from a set of candidate places is provided. The system includes multiple images, each image being associated with a part of the set of candidate places, one or more processors, and a machine-readable medium. The machine readable medium includes instructions stored therein, which when executed by the one or more processors, cause the processors to perform operations including displaying multiple images to multiple users, each image being associated with a part of the set of candidate places, receiving indications of selections of one of the images from the users, and reducing the set of candidate places based on the one of the images selected by a majority of the users.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example of an interface that can be used to select images for selecting a place according to certain aspects of the disclosure.

FIG. 2 illustrates an example of the interface shown in FIG. 1 after selection of an image according to certain aspects of the disclosure.

FIG. 3 illustrates an example of an architecture for selecting a place from a set of candidate places according to certain aspects of the disclosure.

FIG. 4 is a block diagram illustrating examples of a client and a server from the architecture of FIG. 3 according to certain aspects of the disclosure.

FIG. 5 is a flow diagram of an example technique according to aspects of the disclosure.

FIG. 6 conceptually illustrates an example of an electronic system with which some aspects of the subject technology can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

In some aspects, the subject technology addresses issue with collecting rating and review information about places by providing a game application. The application can generate a set of candidate places. For example, the set of candidate places can be a set of 20 restaurants, stores, other businesses, vacation locations, or other places within some specified geographic area. The geographic area can be specified by a user, by a device such as a GPS enabled smart phone, or in other ways. For another example, the set of places can correspond to results of a search request.

The application can group the candidate places into parts, for example two halves. The application can then present some information for display to a user about each part. For example, the presented information can be two images corresponding to the two halves of the set of candidate places. Each image can be associated with one of the halves, for example by being associated with one of the places in the half.

The user can be asked to choose one of the images. When the application receives an indication of the chosen image, the candidate set of places can be reduced to the half associated with that image. The process of presenting images and receiving choices can be repeated until only one candidate place remains. That candidate can be provided to the user as a winning place.

In some other aspects, the application can be used by many users, and statistical analysis can be performed on the selected places. For example, the set of candidate places can be reduced based on images selected by a majority of users. In other aspects, a different user can make choices during the process of reducing the number of candidate places. These aspects can be combined. A possible advantage of these approaches is that collective knowledge about the candidate places can result in a better selection of a place.

Another possible advantage of the subject technology can include permitting users to give ratings for places before they have visited those places. This can encourage users to avail themselves of the subject technology to choose a place to visit, which in turn can further encourage use of the subject technology. Yet another possible advantage is that a relatively small number of choices can be used to screen a large number of places. For example, 100 places could be screened by less than 10 image choices. Such ease of use can also encourage users to use the subject technology in real time just before visiting a place, which in turn can provide useful time information such as winners for different times of the day or days of the week. The subject technology is not limited to these possible advantage, some or all of which may not be realized for all instances of the technology. Additional advantages may also be realized.

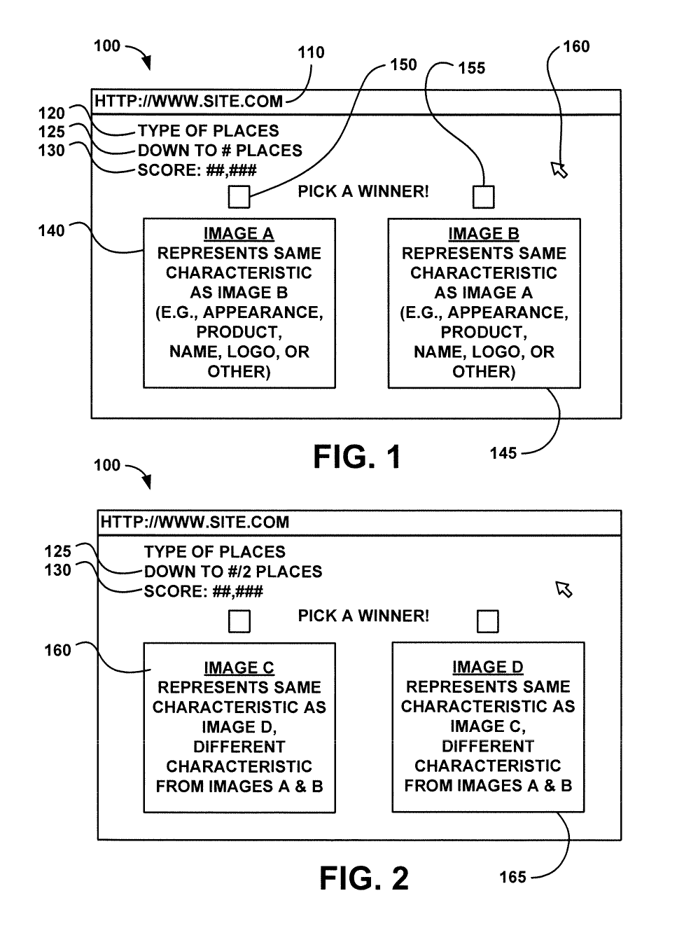

FIG. 1 illustrates an example of an interface that can be used to select images for selecting a place according to certain aspects of the disclosure.

Interface 100 in FIG. 1 is shown as being provided by a website at uniform resource location (URL) 110. An interface according to aspects of the disclosure can be provided locally or remotely by an application or computing device.

Interface 100 is shown with type of place indicator 120, number of candidates indicator 125, score indicator 130, elements 140 and 145 in the form of images A and B, selection boxes 150 and 155, and cursor 160. The subject technology is not limited to these particular elements.

Type of place indicator 120 can describe some characteristic for a set of candidate places. In some aspects, selection of candidates for the set can be made by settings or options specifying a category of places (e.g. vegetarian, sushi, or steak restaurants), a purpose for visiting one of the places (e.g., breakfast, lunch, or dinner), a size of party that will visit one of the places, (e.g., people), a geographic area, a distance from a selected or current location such as determined by a GPS enabled device, a price range for some good or service offered by the places, and any other settings or options. Many techniques for generating the set of candidate places can be used, for example but not limited to a web based search or another type of search of a data repository. Any other settings, options, and techniques can be used to select the set of candidate places.

Number of candidates indicator 125 can show how many candidates are in the set of candidate places. If a user determines that the number is too high, a new set of candidate places can be selected, for example as described above.

Score indicator 130 can show a user's score, for example for a current session or from past sessions using the subject technology. For example, users whose choices closely match other users' choices can be given good scores. For another example, users whose choices result in winning places that then receive positive reviews from people who actually visit those places can be given good scores. Other techniques for generating scores for users can be used.

In other aspects, an indication of a benefit or incentive can accompany or replace score indicator 130. Thus, score indicator 130 generally represents any form of encouragement for a user to select a place using the subject technology. However, such encouragement can be omitted. For example, users who have experience with the subject technology can deem that the functionality of the technology is sufficient encouragement.

Elements 140 and 145 are shown in FIG. 1 as two images. According to aspects of the disclosure, these images represent two parts of the set of candidate places. More than two images corresponding to more than two parts can be shown. For example, and without limitation, three or four images can be shown, corresponding to three or four parts of the set of candidate places.

The set of candidate places can be divided into parts on any basis. In some aspects, the set is divided into parts of approximately equal size. Here, “approximately” accounts for division of odd numbered sets into parts that differ by one candidate. In other aspects, the set can be divided on some other basis. For example, settings, options, and techniques similar to those used to select the set of candidates can be used to further divide the set into parts. In some aspects, each part of the set has some common characteristic. For example, and without limitation, each part can have or belong to a common or similar sub-category of places (e.g. American vegetarian or Far East vegetarian), purpose for visiting, size of party, geographic area, distance from a selected or current location, or price range. For another example, candidate places in one part could have a common characteristic, with one or more other parts including those candidate places that do not have that characteristic. Any other technique for dividing the candidate set into parts can be used.

In some aspects, each image corresponds to a place in each part of the set of candidate places. In other aspects, each image corresponds to some common characteristic for each part of the set of candidate places.

Examples of images that can be used include, but are not limited to, an appearance of a place, an image of a product available at a place, a name of a place, or a logo associated with a place. Other examples include but are not limited to a photo of the place, a menu of food, goods, or other services provided at a place, colors, shapes, or patterns that can imply or remind people of a place, and any other image associated in any way with a place or a part of the set of candidates.

In addition, in still other aspects, information other than images can be used for elements 140 and 145. Any information that is associated in any way with a place or a part of the set of candidates can be used.

In some aspects, elements 140 and 145 displayed together represent some common characteristic associated with each part of the set of candidates. Thus, FIG. 1 shows that image A and image B (i.e., examples of elements 140 and 145) represent a same characteristic of their respective parts of the set of candidates. For example, both images could be of a product available at one of the places in each of the respective parts of the set of candidates. Other characteristics can correspond to any of the types of images that can be used as described above (e.g., appearance, names, logos, photos, menus, colors, shapes, patterns, and any other shared characteristics), any basis for dividing a set of candidates into parts, and any other category or basis for comparing the parts of the set of candidates.

FIG. 1 also shows selection boxes 150 and 155 that can be selected using cursor 160 to choose one of elements 140 and 145. Other techniques for choosing one of the elements can be used, for example but not limited to clicking on one of the elements.

FIG. 2 illustrates an example of the interface shown in FIG. 1 after selection of an image according to certain aspects of the disclosure. In FIG. 2, number of candidates indicator 125 shows approximately half as many candidates remaining in the set of candidates places. This reduction in the number of candidates can represent that the set of candidate places has been reduced to the part of the set corresponding to a choice of element 140 or 145. In other aspects, that part of the set of candidates may have a different number of candidates than half the prior set. Number of candidates indicator 125 can reflect this as well. Score indicator 130 can be updated based on a previous choice by the user or some other factor.

New elements 160 and 165, namely images C and D, can be displayed by interface 100 as shown in FIG. 2 after a choice of one of elements 140 and 145 has been made. In some aspects, a characteristic represented by these elements can differ from a characteristic represented before that choice. Again, the elements shown together can represent a common characteristic. Thus, images C and D, which are examples of elements 160 and 165, represent a same characteristic of their respective parts of the set of candidates, but represent a different characteristic from images A and B. In other aspects, the characteristic represented by the elements need not change after successive choices.

After another choice is made by a user, interface 100 can be updated again. This process can be repeated until only one candidate place remains. In some aspects, a single user can make successive choices to reduce the set of candidate places to one place. In other aspects, different users can make choices, for example through instances of different interfaces such as interface 100.

Certain aspects of the subject technology can declare the remaining candidate place to be a winner. Thus, interface 100 in FIGS. 1 and 2 show the instructions “Pick a Winner!” Alternatively, interface 100 can provide a different instruction, for example but not limited to “Pick a Loser,” and the remaining candidate place can be declared a loser.

Other aspects of the subject technology can apply statistical analysis to multiple iterations of the selection process in order to generate rankings. These rankings and/or results of the statistical analysis can be presented to users of the subject technology and to other people. This information can then be used to select a place to visit, to select a place for a more in-depth review, or for any other purpose where rankings can be used.

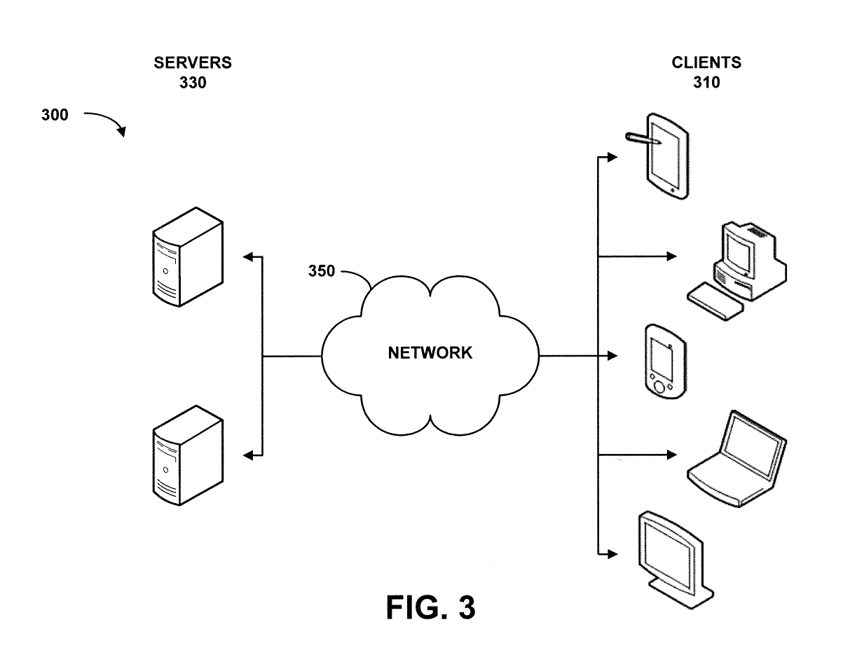

FIG. 3 illustrates an example of architecture 300 for selecting a place from a set of candidate places according to certain aspects of the disclosure. The architecture 300 includes servers 330 and clients 310 connected over a network 350.

One of the many servers 330 can be configured to host images, other data, and instructions to provide an interface and to perform processing in order to permit one or more users to select a place from a set of candidate places according to certain aspects of the disclosure.

For purposes of load balancing, multiple servers 330 can host such images, other data, and/or instructions (or portions thereof). Alternatively, one of the many clients can host can perform the operations discussed in this disclosure without the assistance of a server.

In this regard, and in example aspects, one or more servers 330 can host a search engine system. The search engine system can be usable by users at client device 310. In this regard, one or more servers 330 may provide for accessing, fetching, aggregating, processing, searching, or maintaining documents (e.g., from the Internet).

Some of servers 330 may implement a data aggregation service by crawling a corpus of documents (e.g., web documents), indexing entity location information (e.g., business locations) extracted from the documents, and storing the entity location information associated with the documents in a repository. The data aggregation service may be implemented in other ways, for example, by agreement with the operator(s) of one or more servers 330 to distribute content from their hosted documents via the data aggregation service.

The search engine system hosted on some of servers 330 can perform a search in response to a query received from one or more of clients 310, and can generate search results based on the query. The search results can be displayed in the form of a search results page for display on at least some of clients 310. The search results can for some, all, or part of a set of candidate places from which a place is selected according to aspects of the disclosure. One or more of servers 330 can provide the set of candidate places in other ways as well, for example based on geographical information about or provided through one or more of clients 310.

In other aspects, selected places can be used to rank search results in response to search queries. For example, results of a search query that has been entered by multiple users can be subjected to multiple iterations of operations described in this disclosure. The places selected through those operations can be used to rank the search results for future searches based on that search query or similar search queries.

Clients 310 and servers 330 can be any computing devices having processing hardware, memory, and communications capability necessary to perform some or all of the techniques disclosed herein. Clients 310 to which servers 330 are connected over the network 350 can be, for example, desktop computers, mobile computers, tablet computers (e.g., including e-book readers), mobile devices (e.g., a smartphones or personal digital assistants), set top boxes (e.g., for a television), video game consoles, or any other devices having memory, processing hardware, and communications capabilities for selecting a place from a set of candidate place according to certain aspects of this disclosure.

The network 350 can include, for example, any one or more of a personal area network (PAN), a local area network (LAN), a campus area network (CAN), a metropolitan area network (MAN), a wide area network (WAN), a broadband network (BBN), a peer-to-peer network, an ad-hoc network, the Internet, and the like. Further, the network can include, but is not limited to, any one or more network topologies such as a bus network, a star network, a ring network, a mesh network, a star-bus network, tree or hierarchical network, and the like. The communications modules can be, for example, modems or Ethernet cards.

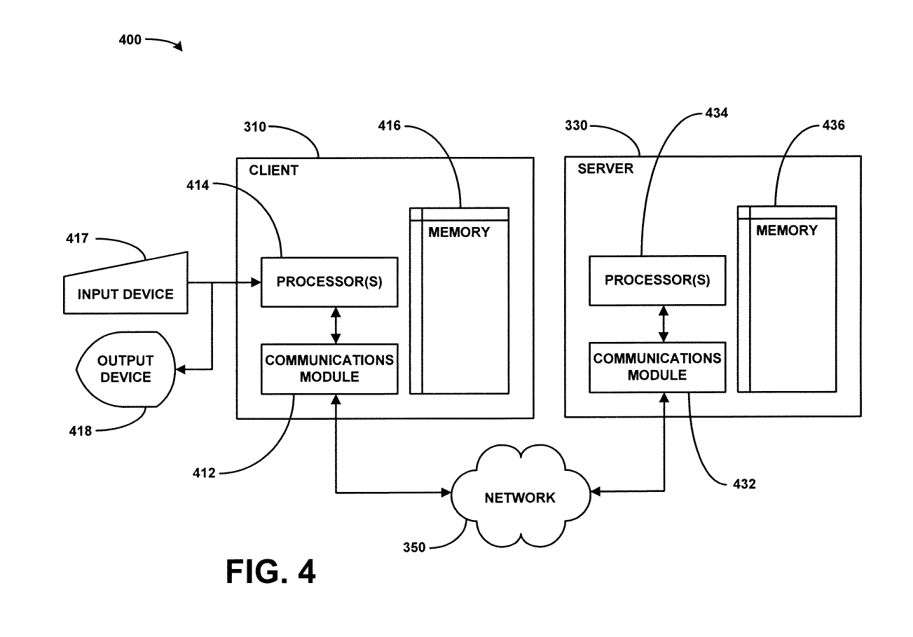

FIG. 4 is a block diagram 400 illustrating examples of client 310 and server 330 in architecture 300 of FIG. 3 according to certain aspects of the disclosure. Client 310 and server 330 are connected over the network 350 via respective communications modules 412 and 432. Communications modules 412 and 432 are configured to interface with network 350 to send and receive information, such as data, requests, responses, and commands to other devices on the network. Communications modules 412 and 432 can be, for example, modems or Ethernet cards.

Both client 310 and server 330 can include processing hardware and some form of memory. In FIG. 4, client 310 includes processor 414 and memory 416, and server 330 includes processor 434 and memory 436. Memory 416 and 436 can be volatile or non-volatile memory. Client 310 also can include input device 417 and output device 418 for accepting input from and providing output to a user. Server 330 also can include such input and output devices.

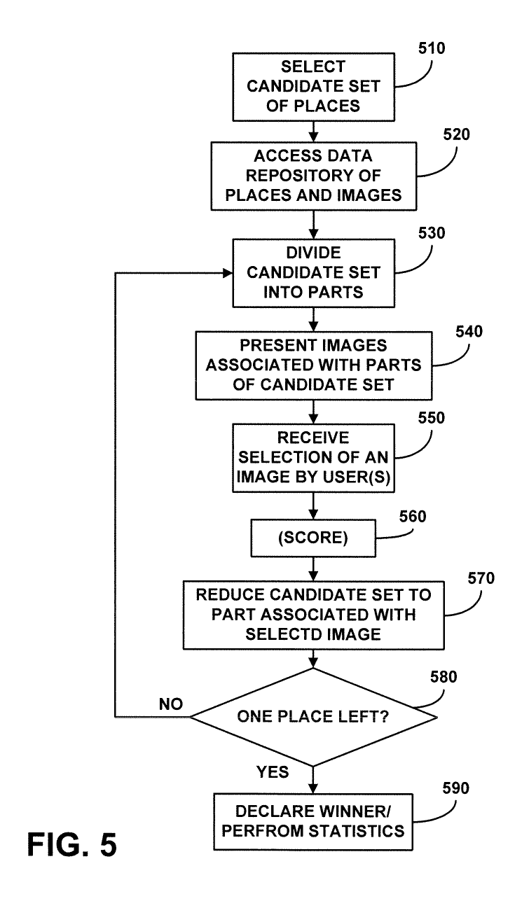

FIG. 5 is a flow diagram of an example technique according to aspects of the disclosure. This technique can be used to provide an interface such as shown in FIGS. 1 and 2 or another interface in order to permit one or more users to select a place from a set of candidate places according to certain aspects of the disclosure.

A candidate set of places can be selected in step 510 of FIG. 5, for example as described above with respect to category indicator 120 of FIG. 1. Other techniques can be used to select the candidate set of places.

A repository that stores data, information describing candidate places, and images representing characteristics of those candidates places can be accessed in step 520. This repository can be access from or stored in any computing device or system, including but not limited to those disclosed herein. In some aspects, the candidate places accessed from the repository can correspond to results of a search by one or more users.

In step 530, the set of candidate places can be divided into parts, for example as described above with respect to elements 140 and 145 (images A and B) of FIG. 1. Other techniques for dividing the candidate set into two or more parts can be used.

Images representing the parts of set of candidate places can be presented for display to a user in step 540, either remotely or locally. In some aspects, one image can be presented for each part. In other aspects, more than one image can be presented for each part. In still other aspects, information other than images can be presented.

An indication of a selection of one of the images (or other information) can be received in step 550. This selection can be used to update a user's score, if one exists, in step 560. Such a score can be updated based on other information as well.

The set of candidate places can be reduced in step 570 based on the selected image, for example to the part associated with the selected image (or other information). Reduction of the set can be performed by discarding data for candidate places not in that part, by indexing, by changing a list of pointers, or by any other computer-implemented technique for designating and changing membership in a set or list. In various aspects, the set of candidate places can be reduced in step 570 based on selections by one user or by multiple users.

Decision step 580 can direct flow to step 590 if only one place remains in the set of candidate places. In other aspects, a different decision can be made. For example, flow can be directed to step 590 if the set is reduced to below some number of places greater than one. For another example, the decision can be based on a number of selections that have been made by user(s), a number of users who have made selections, or an elapsed processing time. Other decisions can be used.

If decision step 580 does not direct flow to step 590, then flow can be directed back to step 530 for further processing.

The remaining place(s) in the set of candidate places can be declared to be winner(s), loser(s), or otherwise processed and analyzed in step 590. In some aspects, the remaining place(s) can be used to rank results of a search query, for example a search query that resulted in the set of candidate places in step 510, or a similar future search query.

The steps in FIG. 5 can be executed in interaction with one user or with a group of users, through one interface or through several interfaces. Additional variations, including adding steps and omitting steps, also can be executed according to the subject technology.

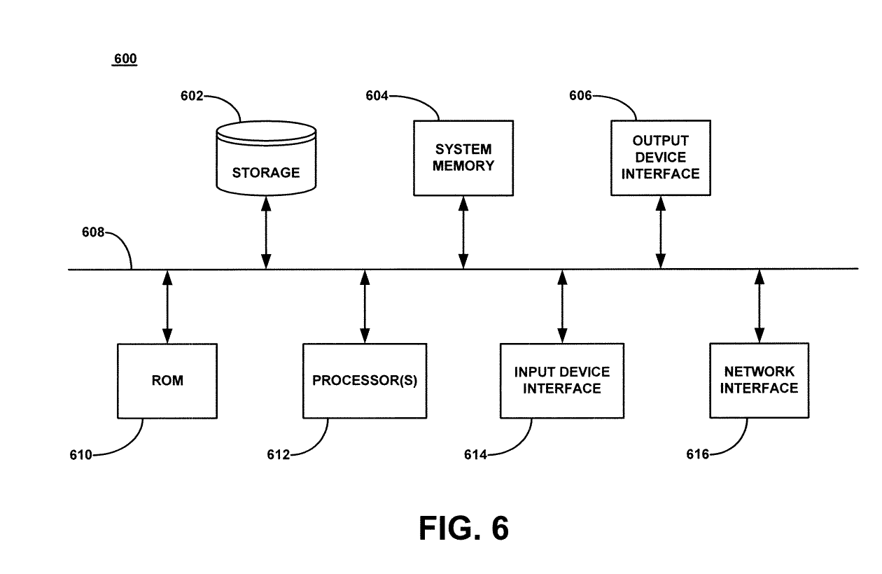

FIG. 6 conceptually illustrates an example of an electronic system with which some aspects of the subject technology can be implemented. Electronic system 600 can be a computer, phone, PDA, or any other sort of electronic device, including but not limited to client 310 and server 3130. Electronic system 600 can also be embedded in another device, for example, and without limitation, a mobile telephone, a personal digital assistant (PDA), a mobile audio player, a Global Positioning System (GPS) receiver, a video game console, a television set top box, a client such as client 310, and/or a server such as server 330.

Such an electronic system can include various types of computer readable media and interfaces for various other types of computer readable media. Electronic system 600 includes a bus 608, processing unit(s) 612, a system memory 604, a read-only memory (ROM) 610, a permanent storage device 602, an input device interface 614, an output device interface 606, and a network interface 616.

Bus 608 collectively represents all system, peripheral, and chipset buses that communicatively connect the numerous internal devices of electronic system 600. For instance, bus 608 communicatively connects processing unit(s) 612 with ROM 610, system memory 604, and permanent storage device 602.

From these various memory units, processing unit(s) 612 retrieves instructions to execute and data to process in order to execute the processes of the subject disclosure. The processing unit(s) can be a single processor or a multi-core processor in different implementations.

ROM 610 stores static data and instructions that are needed by processing unit(s) 612 and other modules of the electronic system. Permanent storage device 602, on the other hand, is a read-and-write memory device. This device is a non-volatile memory unit that stores instructions and data even when electronic system 600 is off. Some implementations of the subject disclosure use a mass-storage device (such as a magnetic or optical disk and its corresponding disk drive) as permanent storage device 602.

Other implementations use a removable storage device (such as a floppy disk, flash drive, and its corresponding disk drive) as permanent storage device 602. Like permanent storage device 602, system memory 604 is a read-and-write memory device. However, unlike storage device 602, system memory 604 is a volatile read-and-write memory, such a random access memory. System memory 604 stores some of the instructions and data that the processor needs at runtime. In some implementations, the processes of the subject disclosure are stored in system memory 604, permanent storage device 602, and/or ROM 610. For example, the various memory units can include instructions for selecting a place from a set of candidate place according to certain aspects of the disclosure. From these various memory units, processing unit(s) 612 retrieves instructions to execute and data to process in order to execute the processes of some implementations.

Bus 608 also connects to input and output device interfaces 614 and 606. Input device interface 614 enables the user to communicate information and select commands to the electronic system. Input devices used with input device interface 614 include, for example, alphanumeric keyboards and pointing devices (also called “cursor control devices”). Output device interfaces 606 enables, for example, the display of images generated by the electronic system 600. Output devices used with output device interface 606 include, for example, printers and display devices, such as cathode ray tubes (CRT) or liquid crystal displays (LCD). Some implementations include devices such as a touchscreen that functions as both input and output devices.

Finally, as shown in FIG. 6, bus 608 also couples electronic system 600 to a network (not shown) through a network interface 616. In this manner, the computer can be a part of a network of computers such as network 350. Any or all components of electronic system 600 can be used in conjunction with the subject disclosure.

The operations described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, PROM, EPROM, FLASH EPROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, floppy disks, and any other memory chip or cartridge, or any other medium from which a computer can read.

The machine-readable storage medium can be a machine-readable storage device, a machine-readable storage substrate, a memory device, a composition of matter effecting a machine-readable propagated signal, or a combination of one or more of them.

The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations can be performed by one or more integrated circuits, such as application specific integrated circuits (ASICs) or field programmable gate arrays (FPGAs). In some implementations, such integrated circuits execute instructions that are stored on the circuit itself.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Various aspects of the subject matter described in this disclosure can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network.

A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Likewise, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

These and other implementations are within the scope of the following claims.

1. A computer-implemented method of selecting a place from a set of candidate places, comprising:
generating, using one or more computing devices, a set of candidate places;
dividing, using one or more computing devices, the set of candidate places into a plurality of parts;
presenting, using one or more computing devices, a plurality of images for display to a user, each image from the plurality of images being associated with a respective part of the plurality of parts of the set of candidate places;
receiving, using one or more computing devices, an indication of a user selection of one of the plurality of images;
reducing, using one or more computing devices, the set of candidate places to the respective part of the plurality of parts of the set of candidate places associated with the user selected image;
repeating, using one or more computing devices, the dividing, presenting, receiving, and reducing steps, until the reduced set of candidate places includes only one candidate place; and
designating, using one or more computing devices, the one candidate place selected from the set of candidate places as a winning place.

2. The computer-implemented method of claim 1, wherein the set of candidate places correspond to results of a search.

3. The computer-implemented method of claim 2, further comprising the step of using the reduced set of candidate places to rank the results of the search.

4. The computer-implemented method of claim 1, wherein the image associated with each respective part of the set of candidate places comprises an image of a characteristic of a place in that part of the set of candidate places.

5. The computer-implemented method of claim 4, wherein the characteristic of the place comprises an appearance of the place, an image of a product available at the place, a name of the place, or a logo associated with the place.

6. The computer-implemented method of claim 1, wherein the plurality of images presented by each repetition of the presenting step comprise images representing a same characteristic of each part of the set of candidate places.

7. The computer-implemented method of claim 1, wherein the plurality of images presented by a first repetition of the presenting step and the plurality of images presented by a second repetition of the presenting step subsequent to the first repetition, include images representing different characteristics.

8. The computer-implemented method of claim 1, wherein each part of the set of candidate places comprises approximately a same number of places as each other part of the set of candidate places.

9.-10. (canceled)

11. The computer-implemented method of claim 1, wherein two different repetitions of the receiving step receive the indication of the selection of one of the images from two different users.

12. The computer-implemented method of claim 11, further comprising the step of scoring each user of the two different users based on the selection by that user.

13. A non-transitory machine-readable storage medium comprising machine-readable instructions for causing a processor to execute a method of selecting a place from a set of candidate places, the method comprising:
generating a set of candidate places:
dividing the set of candidate places into two parts;
presenting, for display to a user, two images, each image being associated with a respective part of the set of candidate places;
receiving an indication of a user selection of one of the images; and
reducing the set of candidate places to the respective part of the set of candidate places associated with the user selected image.

14. The machine-readable storage medium of claim 13, wherein the set of candidate places correspond to results of a search.

15. The machine-readable storage medium of claim 14, wherein the method further comprises the step of using the reduced set of candidate places to rank the results of the search.

16. The machine-readable storage medium of claim 13, wherein the image associated with each part of the set of candidate places comprises an image of a characteristic of a place in that part of the set of candidate places.

17. The machine-readable storage medium of claim 16, wherein the characteristic of the place comprises an appearance of the place, an image of a product available at the place, a name of the place, or a logo associated with the place.

18. The machine-readable storage medium of claim 13, wherein each part of the set of candidate places comprises approximately half of the set of candidate places.

19. The machine-readable storage medium of claim 13, wherein the method further comprises repeating the steps of presenting, receiving, and reducing until the set of candidate places is includes only one candidate place.

20. The machine-readable storage medium of claim 19, wherein the method further comprises the step of designating the only one candidate place as a winning place.

21. The machine-readable storage medium of claim 19, wherein two different repetitions of the receiving step receive the indication of the selection of one of the images from two different users.

22. The machine-readable storage medium of claim 21, wherein the method further comprises the step of scoring each user of the two different users based on the selection by that user.

23. A system for selecting a place from a set of candidate places, the system comprising:
one or more processors; and
a machine-readable medium comprising instructions stored therein, which when executed by the one or more processors, cause the processors to perform operations comprising:
displaying multiple images to multiple users, each image being associated with a respective part of the set of candidate places;
receiving indications of user selections of one image of the multiple images from the multiple users; and
reducing the set of candidate places to the respective part of the set of candidate places associated with the images selected by a majority of the users.

24. The system of claim 23, wherein the set of candidate places correspond to results of a search.

25. The system of claim 24, wherein the operations further comprise using the reduced set of candidate places to rank the results of the search.

26. The system of claim 23, wherein the image associated with each part of the set of candidate places comprises an image of a characteristic of a place in that part of the set of candidate places.

27. The system of claim 26, wherein the characteristic of the place comprises an appearance of the place, an image of a product available at the place, a name of the place, or a logo associated with the place.

28. The system of claim 23, wherein each part of the set of candidate places comprises approximately half of the set of candidate places.

29. The system of claim 23, wherein the operations further comprise repeating the operations of displaying, receiving, and reducing until the set of candidate places includes only one candidate place.

30. The system of claim 23, wherein the operations further comprise scoring each user of the multiple users based on the selection by that user.
